(19) United States
(12) Patent Application Publication
(10) Pub. No.: US 2013/0163862 A1
(43) Pub. Date: Jun. 27, 2013

(54) IMAGE PROCESSING METHOD AND DEVICE FOR REDEYE CORRECTION

(71) Applicant: Min-Jung Huang, Hsinchu City (TW)

(72) Inventor: Min-Jung Huang, Hsinchu City (TW)

(73) Assignee: ICATCH TECHNOLOGY INC., Hsinchu (TW)

(21) Appl. No.: 13/425,426

(22) Filed: Mar. 21, 2012

(30) Foreign Application Priority Data
Dec. 27, 2011 (TW) 100148945

(51) Int. Cl. G06K 9/34

(52) U.S. Cl. 382/164

(57) ABSTRACT

An image processing method and a device for redeye correction are provided. In the method, a face region of a pending image is received and detected. At least one region of interest (ROI) is set in the face region. The ROI is segmented according to a color model so as to produce a plurality of candidate regions. Each of the candidate regions is filtered separately according to a candidate region filtering method. It is determined whether a color candidate region is produced after filtering. If yes, luminance values of a plurality of pixels in the ROI are calculated by a contrast mask. The ROI is segmented by using a calculated luminance distribution so as to produce a high contrast candidate region. An overlapped portion between the color and the high contrast candidate regions is taken as a redeye region, and the redeye region is corrected to produce a corrected image.

### CROSS-REFERENCE TO RELATED APPLICATION

This application claims the priority benefit of Taiwan application serial no. 100148945, filed on Dec. 27, 2011. The entirety of the above-mentioned patent application is hereby incorporated by reference herein and made a part of this specification.

### BACKGROUND OF THE INVENTION

1. Field of the Invention

The invention relates to an image processing method and a device. Particularly, the invention relates to an image processing method and a device for redeye correction.

2. Description of Related Art

A redeye phenomenon refers to a phenomenon that a pupil of human eye presents a red color in a color picture. A main reason thereof is that the pupil of the human eye is enlarged in a dark environment to increase a range of light entering the retina, and when a flashlight is used to take the picture, a strong light of the flashlight irradiates surrounding microvascular tissues in the back of the eye's retina, and a reflected red light may cause the redeye phenomenon on the color picture.

The redeye phenomenon looks awkward and unsightly in a visual effect, which is undesired by a photographer. Therefore, it is an important issue in an image processing technique domain to correct the redeye phenomenon and modify the unnatural redeye phenomenon to its original natural eye color, so as to eliminate the awkward sense.

Referring to U.S. Pat. No. 7,746,385, in this patent, a plurality of previous images captured without using the flashlight is taken as a plurality of reference images, and is compared with a current image captured by using the flashlight, so as to correct the redeye phenomenon in the current image. Before the reference images are compared with the current image, the previous image has to be enlarged and the current image has to be diminished, so as to coincide resolutions of the previous image and the current image. Moreover, since a capturing time of the previous image and a capturing time of the current image are different, in order to avoid an image error caused by hand shake or movement of the photographed object, etc., a geometric alignment has to be performed, and then a redeye region is determined for correction according to a difference of the previous image and the current image.

Then, referring to U.S. Pat. No. 7,852,377, in this patent, a region composed of red pixels is used for geometric discrimination, and based on round discrimination, a round or nearly round region is filtered, and the above region is expanded outwards to determine the redeye region to be corrected with reference of peripheral conditions.

However, in the U.S. Pat. No. 7,746,385, since resolution adjustment and geometric correction, etc. have to be performed first, operation complexity thereof and required resources are relatively high, for example, since multiple reference images have to be accessed, a number and a space of buffers have to be relatively large. Moreover, an application range thereof is limited, for example, if the photographer directly uses the flashlight to take pictures and there is none reference images captured without using the flashlight, the above method cannot be used. Moreover, since the U.S. Pat. No. 7,852,377 mainly takes the round region for discrimination, however, in a picture that actually has the redeye phenomenon, a eye shape is not always a standard round shape, for example, a half-closed eye or a squinted eye, etc., and in case that the face of the photographed person does not directly face to a camera lens, a situation of false positive is probably generated.

### SUMMARY OF THE INVENTION

The invention is directed to an image processing method for redeye correction, which effectively reduces a chance of false judgment, and accurately segments a redeye region to be corrected for automatic correction.

The invention is directed to an image processing device for redeye correction, which directly detects a captured image and quickly segments a redeye region to be corrected for automatic correction, so as to output a corrected image.

The invention provides an image processing method for redeye correction, which includes following steps. A pending image is received, and a face region of the pending image is detected. One or a plurality of region of interest (ROI) is set in the face region. Then, the ROI is segmented according to a color model to produce a plurality of candidate regions. Each of the candidate regions is filtered separately according to a candidate region filtering method, and it is determined whether a color candidate region is produced after filtering. If yes, luminance values of a plurality of pixels in the ROI are calculated by using a contrast mask. The ROI is segmented by using a calculated luminance distribution to produce a high contrast candidate region. An overlapped portion between the color candidate region and the high contrast candidate region is taken as a redeye region, and the redeye region is corrected to produce a corrected image.

In an embodiment of the invention, if it is determined the color candidate region is not produced after filtering, the image processing method further includes filtering the high contrast candidate region according to the candidate region filtering method, and directly taking the filtered high contrast candidate region as the redeye region, so as to correct the redeye region.

In an embodiment of the invention, the step of using the contrast mask to segment the one or a plurality of the ROIs further includes following steps. The contrast mask is used to calculate the luminance values of a plurality of the pixels in the ROI to generate a plurality of response values. A reference center point is positioned according to the response values. Luminance values of a plurality of pixels in a neighboring region of the reference center point are calculated to generate a median luminance value and a standard deviation. Then, the ROI is segmented according to the luminance distribution formed by the median luminance value and the standard deviation, so as to generate the high contrast candidate region.

In an embodiment of the invention, the step of positioning the reference center point according to the response values includes selecting a position of the at least one ROI corresponding to a center point of the contrast mask to serve as the reference center point when a maximum response value in the response values is generated.

In an embodiment of the invention, the step of filtering each of the candidate regions according to the candidate region filtering method includes following steps. A center of the candidate region is taken as a round center, and a first predetermined distance is taken as a radius to form a first round region, and saturation values of a plurality of pixels inside and outside the first round region are calculated to generate a first characteristic value. It is determined whether the first characteristic value is greater than a threshold value. The candidate region is determined to be the color candidate region when the first characteristic value is greater than the threshold value.

In an embodiment of the invention, the image processing method further includes following steps. A center of the candidate region is taken as a round center, and a second predetermined distance is taken as a radius to form a second round region, and saturation values of a plurality of pixels inside and outside the second round region are calculated to generate a second characteristic value. It is determined whether the first characteristic value or the second characteristic value is greater than the threshold value. The candidate region is determined to be the color candidate region when at least one of the first characteristic value and the second characteristic value is greater than the threshold value.

In an embodiment of the invention, the image processing method further includes analysing a relative position relationship of the candidate regions in the face region to filter the color candidate region.

The invention provides an image processing device for redeye correction, which includes a face detection module, a color segment module, a filter module, a contrast mask module and a redeye correction module. The face detection module receives a pending image, and detects a face region of the pending image, and sets one or a plurality of region of interest (ROI) in the face region. The color segment module is coupled to the face detection module, and segments the ROI according to a color model so as to produce a plurality of candidate regions. The filter module is coupled to the color segment module, and filters each of the candidate regions to determine whether a color candidate region is produced after filtering. The contrast mask module is coupled to the filter module, and if the filter module indeed generates the color candidate region after filtering, the contrast mask module calculates luminance values of a plurality of pixels in the ROI by using a contrast mask, and segments the ROI by using a calculated luminance distribution to produce a high contrast candidate region. The redeye correction module is coupled to the filter module and the contrast mask module, takes an overlapped portion between the color candidate region and the high contrast candidate region as a redeye region, and corrects the redeye region to produce a corrected image.

In an embodiment of the invention, when the filter module does not produce the color candidate region after filtering the candidate regions, the filter module further filters the high contrast candidate region to produce a filtered luminance candidate region. The redeye correction module directly takes the filtered high contrast candidate region as the redeye region, so as to correct the redeye region.

In an embodiment of the invention, the contrast mask module includes a positioning unit, a calculation unit and a luminance segment unit. The positioning unit uses the contrast mask to calculate the luminance values of a plurality of the pixels in the ROI to generate a plurality of response values, and positions a reference center point according to the response values. The calculation unit is coupled to the positioning unit, and calculates luminance values of a plurality of pixels in a neighboring region of the reference center point to generate a median luminance value and a standard deviation. The luminance segment unit is coupled to the calculation unit, and segments the ROI according to the luminance distribution formed by the median luminance value and the standard deviation to generate the high contrast candidate region.

In an embodiment of the invention, when the positioning unit generates a maximum response value, the positioning unit selects a position of the at least one ROI corresponding to a center point of the contrast mask to serve as the reference center point.

In an embodiment of the invention, the filter module takes a center of the candidate region generated by the color segment module as a round center, and takes a first predetermined distance as a radius to form a first round region. Moreover, the filter module calculates saturation values of a plurality of pixels inside and outside the first round region to generate a first characteristic value. The filter module determines the candidate region with the first characteristic value being greater than a threshold value to be the color candidate region.

In an embodiment of the invention, the filter module takes a second predetermined distance as a radius to form a second round region, and calculates saturation values of a plurality of pixels inside and outside the second round region to generate a second characteristic value, and the filter module determines the candidate region with at least one of the first characteristic value and the second characteristic value being greater than the threshold value as the color candidate region.

In an embodiment of the invention, the filter module analyses a relative position relationship of the candidate regions generated by the color segment module, and filters the color candidate region according to an analysing result.

According to the above descriptions, in the image processing method and the device for redeye correction, the luminance distribution calculated by using the contrast mask is used to segment the pending image to produce the high contrast candidate region, so as to commonly determine the redeye region to be compensated with reference of the color candidate region, by which accuracy and tolerance for determining the redeye region are increased.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an image processing device for redeye correction according to an embodiment of the invention.

FIG. 2 is a flowchart illustrating an image processing method for redeye correction according to an embodiment of the invention.

FIG. 3 is a block diagram of an image processing device according to another embodiment of the invention.

FIG. 4 is a flowchart illustrating an image processing method for redeye correction according to another embodiment of the invention.

FIG. 5A is a schematic diagram of a contrast mask and a region of interest (ROI) according to another embodiment of the invention.

FIG. 5B is a schematic diagram of a position of a contrast mask obtained when a maximum response value is generated according to another embodiment of the invention.

FIG. 5C is an enlarged view of a reference center point C of FIG. 5B and a plurality of pixels in a neighboring region thereof.

FIG. 6A and FIG. 6B are schematic diagrams respectively illustrating a center and a radius of a candidate region according to still another embodiment of the invention.

### DETAILED DESCRIPTION OF DISCLOSED EMBODIMENTS

The invention provides an image processing method and a device for redeye correction, which can directly process a pending image without using a plurality of reference images for comparison. Moreover, a contrast mask technique is used to filter a more accurate candidate region in which the redeye phenomenon is generated. Moreover, regardless of whether the region that generates the redeye phenomenon is a standard round shape, it can be effectively detected to reduce a chance of false positive. In order to fully convey the content of the invention, embodiments are provided below for descriptions, though the provided embodiments are not used to limit the invention.

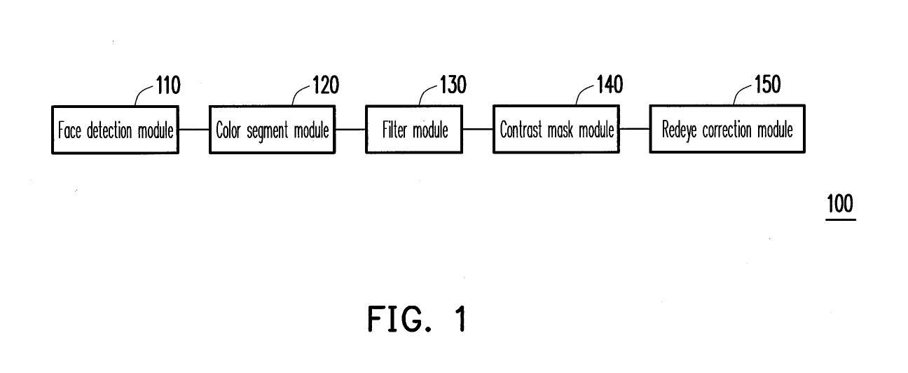

FIG. 1 is a block diagram of an image processing device for redeye correction according to an embodiment of the invention. Referring to FIG. 1, the image processing device 100 of the present embodiment is, for example, a digital camera, a single lens reflex camera, a digital video camera or a smart mobile phone and a flat panel computer, etc. having an image processing function, though the invention is not limited thereto. The image processing device 100 includes a face detection module 110, a color segment module 120, a filter module 130, a contrast mask module 140 and a redeye correction module 150. Each of the above modules can be a function module implemented by hardware and/or software. The hardware can be a hardware equipment having a computation function such as a central processor, a chip set or a microprocessor, etc., or a combination thereof, and the software can be a driving program, an application program or an operating system, etc.

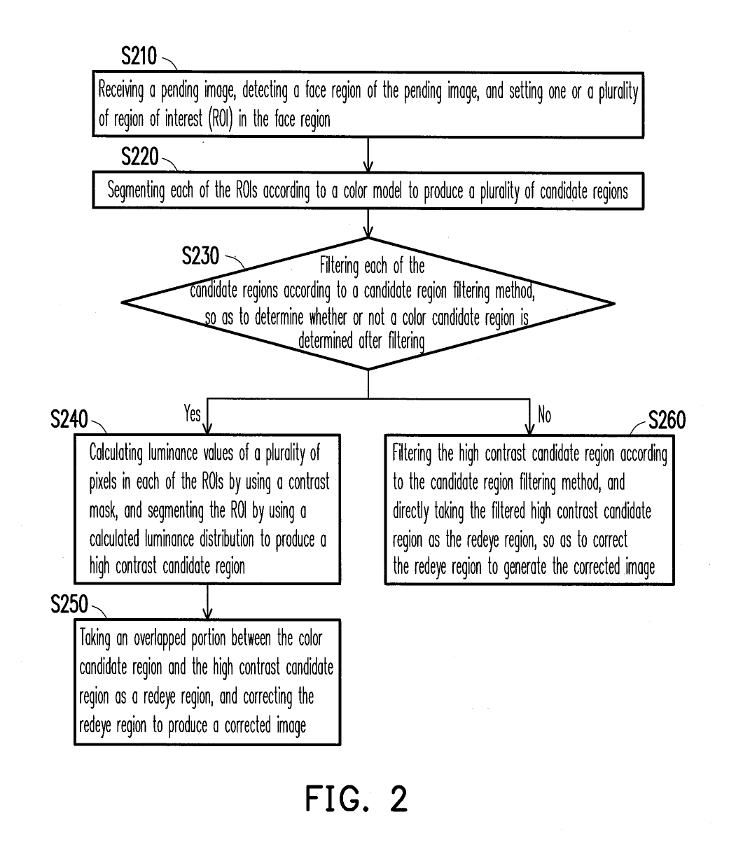

FIG. 2 is a flowchart illustrating an image processing method for redeye correction according to an embodiment of the invention. The method of the present embodiment is suitable for the image processing device 100 of FIG. 1, the image processing method of the present embodiment is described in detail below with reference of the various modules of the image processing device 100.

First, in step S210, the face detection module 110 receives a pending image, and detects a face region of the pending image, and sets one or a plurality of region of interest (ROI) in the face region. An essence of such step is to reduce a searching range so as to reduce a time required for image processing. Since a region that has the redeye phenomenon is located at an eye area, namely, the ROIs have to include the eye area and the surrounding area thereof, after the face detection module 110 detects the face region, it can sets one or a plurality of the ROIs in the face region according to a quick search method, where an area and a number of the ROIs can be designed according to an actual image content, which is not limited by the invention.

Then, in step S220, the color segment module 120 segments each of the ROIs according to a color model so as to produce a plurality of candidate regions. The color model is, for example, an RGB module. Since the region that generates the redeye phenomenon is generally a region gathered with red pixels, where the red pixel refers to a pixel in which the majority of the color component is the red component. Therefore, the color segment module 120 may define a red section of the RGB model, and segment each of the pixels in each of the ROIs. For example, the color segment module 120 segments the pixels belonging to the red section in the ROI as 1, and the other pixels as 0. After each of the pixels is segmented, the pixels belonging to the red section are selected, so as to produce the candidate regions.

After a plurality of the candidate regions is generated, a step S230 is executed, by which the filter module 130 filters each of the candidate regions according to a candidate region filtering method, so as to determine whether or not a color candidate region is produced after filtering. Since besides a pupil area that generates the redeye phenomenon, the candidate regions generated in the step S220 can also be characteristic points that gathered with the red pixels and located at an eye corner and a mouth corner, etc., and the situation of setting the non-pupil area as the candidate region is false positive, which may cause correction error and an excessive correction range. Therefore, in the step S230, the candidate region filtering method is used to further discriminate and filter the candidate regions, and the remained candidate region that satisfies filtering conditions is referred to as the color candidate region. Details of the candidate region filtering method are described in detail in the following embodiments. If it is determined that the color candidate region indeed exists, a step S240 is performed, and if it is determined that the color candidate region does not exist, a step S260 is executed.

In the step S240, the contrast mask module 140 calculates luminance values of a plurality of pixels in each of the ROIs by using a contrast mask, and segments the ROI by using a calculated luminance distribution, so as to produce a high contrast candidate region. In the present embodiment, the luminance value is a pixel value of a Y channel obtained when the pixel is coded according to a YUV format of the color space. Therefore, after a plurality of the pixels of the ROI is calculated, the luminance distribution is obtained. Then, the luminance distribution is used to detect the ROI to segment all of the pixels belonging to the luminance distribution, and selects all of the segmented pixels to obtain the high contrast candidate region.

Then, in step S250, the redeye correction module 150 compares the filtered color candidate region and the high contrast candidate region, and takes an overlapped portion between the color candidate region and the high contrast candidate region as a redeye region, and corrects the redeye region to produce a corrected image.

However, if the color candidate region is not produced, the high contrast candidate region produced by the step S240 is directly filtered according to the candidate region filtering method, and the high contrast candidate region that satisfies a filtering condition is directly taken as the redeye region, and such candidate region is corrected to obtain the corrected image.

In the invention, besides the color model (the red component of the pixel) is used to segment and filter the generated color candidate region, a contrast mask is further used for segmentation, so as to produce the high contrast candidate region, and the color candidate region and the high contrast candidate region are commonly used to determine the optimal redeye region. If only the color model is used for segmentation, it is hard to filter the redeye phenomenon with a lower red component (for example, a red-brown color). However, the redeye phenomenon with the lower red component can be detected by using the contrast mask for a further determination. Therefore, usage of the contrast mask can assist a determination result of the color model, which increases accuracy and tolerance in the redeye region determination.

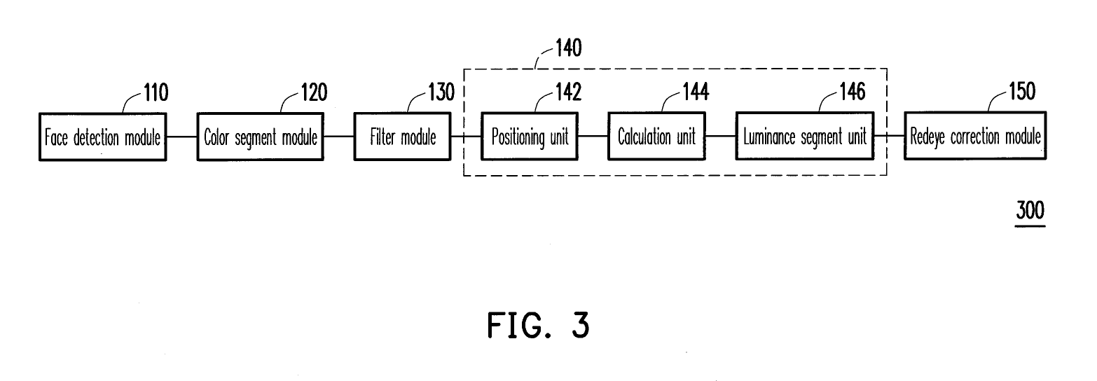

Another embodiment is provided below for determination. FIG. 3 is a block diagram of an image processing device according to another embodiment of the invention. It should be noticed that the embodiment of FIG. 3 is an implementation of the image processing device 100 of FIG. 1. Referring to FIG. 3, the contrast mask module 140 includes a positioning unit 142, a calculation unit 144 coupled to the positioning unit 142 and a luminance segment unit 146 coupled to the calculation unit 144.

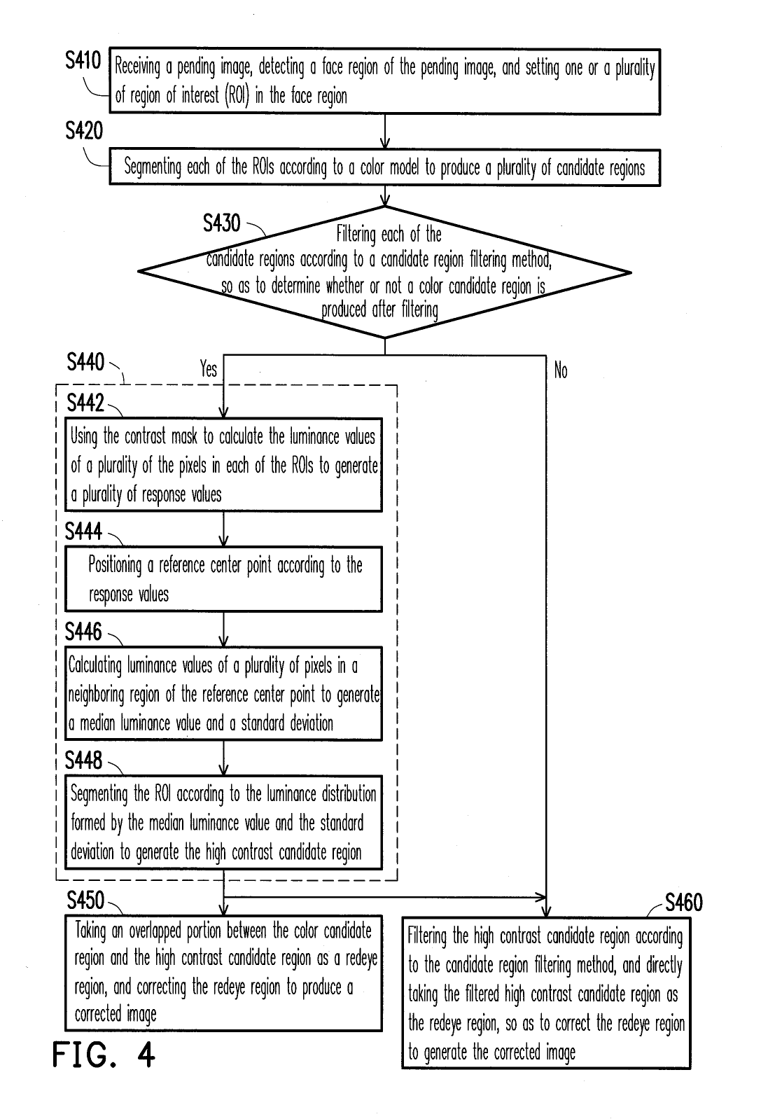

FIG. 4 is a flowchart illustrating an image processing method for redeye correction according to another embodiment of the invention. The flowchart of FIG. 4 is a detailed implementation of the image processing method for redeye correction of FIG. 2. An operation method of the image processing device 300 is introduced below with reference of FIG. 4.

Referring to FIG. 3 and FIG. 4, first, the face detection module 110 first receives a pending image, and detects a face region of the pending image, and sets one or a plurality of region of interest (ROI) in the face region (S410). Then, the color segment module 120 segments each of the ROIs according to a color model so as to produce a plurality of candidate regions (S420). Then, the filter module 130 filters each of the candidate regions according to the candidate region filtering method, so as to determine whether or not a color candidate region is produced after filtering (step S430). The aforementioned steps S410-S430 are the same or similar to the steps S210-S230, and details thereof have been described in the aforementioned embodiment, which are not repeated herein.

Then, the step S440 of using the contrast mask to segment each of the ROIs to generate the high contrast candidate region is implemented by steps S442-S448.

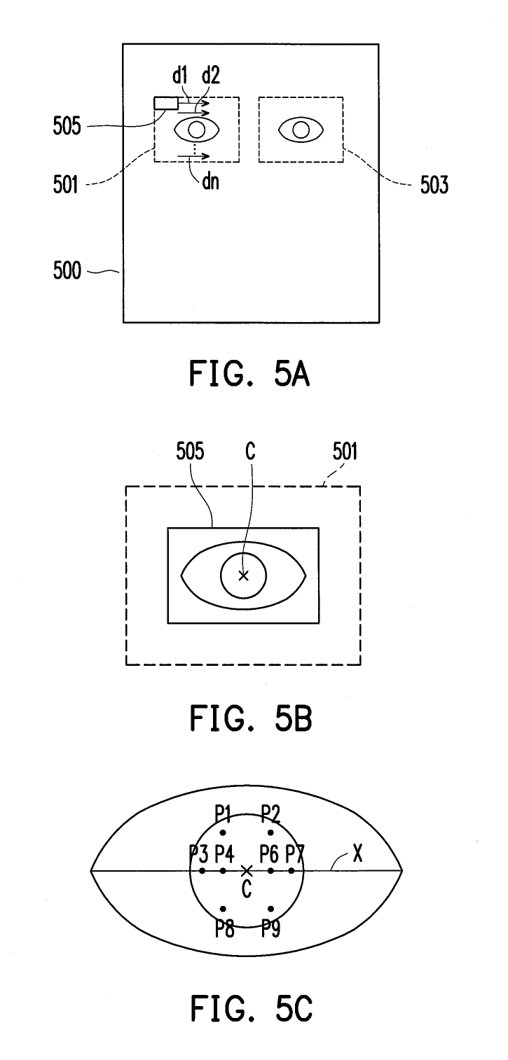

In the step S442, the positioning unit 142 uses the contrast mask to calculate the luminance values of a plurality of the pixels in each of the ROIs to generate a plurality of response values. FIG. 5A is a schematic diagram of a contrast mask and a ROI according to another embodiment of the invention. Referring to FIG. 5A, a pending image 500, for example, includes two ROIs 501 and 503, and the positioning unit 142 uses a contrast mask 505 to scan in the ROI 501, i.e. sequentially calculates along arrow directions d1, d2, . . . , dn from the top to the bottom, where the positioning unit 142 uses the contrast mask 505 to calculate the luminance values of a part of the pixels within a coverage range of the ROI 501 to generate the response values, where the closer to the eye, the larger the response value is.

In the step S444, the positioning unit 142 positions a reference center point according to the response values generated in the ROI 501. In detail, the positioning unit 142 first selects a maximum response value in the response values, and obtains a position of the contrast mask 505 obtained when the maximum response value is generated. For example, FIG. 5B is a schematic diagram of a position of the contrast mask obtained when the maximum response value is generated according to another embodiment of the invention. Referring to FIG. 5B, a position of the ROI 501 corresponding to a center point of the contrast mask 505 is selected to serve as the reference center point C.

In the step S446, the calculation unit 144 calculates luminance values of a plurality of pixels in a neighboring region of the reference center point C to generate a median luminance value M and a standard deviation S. For example, FIG. 5C is an enlarged view of the reference center point C of FIG. 5B and a plurality of pixels in the neighboring region thereof. Referring to FIG. 5C, the median luminance value M can be calculated by using the luminance values of pixels P1-P9 (where, the pixel P5 is the reference center point C). Selection of the neighboring pixels (i.e. the pixels P1-P9) of FIG. 5C is only an example, and the invention is not limited thereto. Then, the median luminance value M is compared to the neighboring pixels of the reference center point C to generate the standard deviation S, where the neighboring pixels are, for example, a plurality of pixels on a horizontal axis while taking the reference center point C as a center.

In the step S448, the luminance segment unit 146 segments the ROI 501 according to the luminance distribution formed by the median luminance value M and the standard deviation S, so as to generate the high contrast candidate region.

Finally, the redeye correction module 150 compares the filtered color candidate region and the high contrast candidate region, and takes an overlapped portion between the color candidate region and the high contrast candidate region as a redeye region, and corrects the redeye region to produce a corrected image (step S450). However, if the color candidate region is not produced, the high contrast candidate region produced by the step S440 is directly filtered according to the candidate region filtering method, and the high contrast candidate region that satisfies a filtering condition is directly taken as the redeye region, and the redeye correction module 150 corrects such candidate region to obtain the corrected image (S460).

Another embodiment is provided below to describe the step of filtering each of the candidate regions according to the candidate region filtering method in detail. It should be noticed that if the candidate region is a candidate region segmented by the color model, it can be determined as the color candidate region according to the candidate region filtering method, which can be used to compare with the high contrast candidate region to determine the redeye region to be compensated. If the candidate region is a candidate region segmented by the contrast mask, it can be directly determined as the redeye region according to the candidate region filtering method.

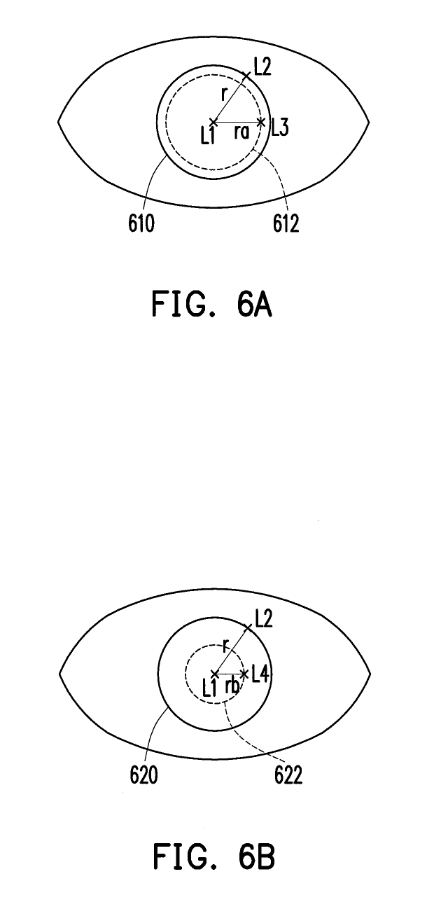

FIG. 6A and FIG. 6B are schematic diagrams respectively illustrating a center and a radius of a candidate region according to still another embodiment of the invention. Various steps of the present embodiment can be implemented by the filter module 130 of FIG. 1 or FIG. 3.

Referring to FIG. 6A and FIG. 6B, it should be noticed that a simple morphotogical process has to be first performed on the candidate regions, and a positioning point L1 of the candidate region is taken as a round center, and a distance r between the positioning point L1 and a positioning point L2 is taken as a radius to form round candidate regions 610 and 620.

As shown in FIG. 6A, a first predetermined distance ra (i.e. a distance between the positioning point L1 and a positioning point L3) is taken as a radius to form a first round region 612, and saturation values of a plurality of pixels inside and outside the first round region 612 are calculated to generate a first characteristic value. In detail, in the present embodiment, the saturation value is, for example, a pixel value of a V channel obtained when the pixel is coded according to a YUV format of the color space. A difference between the saturation values of a plurality of pixels inside the first round region 612 and the saturation values of a plurality of pixels outside the first round region 612 is used to serve as the first characteristic value. Then, it is determined whether the first characteristic value is greater than a threshold value. When the first characteristic value is greater than the threshold value, it represents that the candidate region satisfies the filtering condition.

As shown in FIG. 6B, a second predetermined distance rb (i.e. a distance between the positioning point L1 and a positioning point L4) is taken as a radius to form a second round region 622, and saturation values of a plurality of pixels inside and outside the second round region 622 are calculated to generate a second characteristic value. Then, it is determined whether the second characteristic value is greater than the threshold value. When the second characteristic value is greater than the threshold value, it represents that the candidate region satisfies the filtering condition.

It should be noticed that the candidate region filtering method of the embodiment can be used to sequentially determine whether the first characteristic value or the second characteristic value is greater than the threshold value. If at least one of the first characteristic value and the second characteristic value is greater than the threshold value, it represents that the candidate region satisfies the filtering condition. Moreover, in order to increase an inspection accuracy, a distribution of the pixel sampling points can be adjusted by several times, or repeated confirmation is performed by using different predetermined distances as the radius. In this way, even if a proportion of the region that generates the redeye phenomenon in the pupil is different, it can still be determined whether the region is the redeye region, for example, the redeye region probably occupies the whole pupil area, or occupies a half of the pupil area due to that the eye is half closed. Finally, if it is confirmed that the candidate region cannot pass through the test of the candidate region filtering method according to different filtering conditions, it represents that the candidate region is false positive, i.e. the candidate region is not located in the redeye region.

In summary, in the invention, the pending image can be directly processed without using a plurality of reference image for comparison as that does of the conventional technique, so as to save a system resource and reduce computation complexity. Moreover, the luminance distribution calculated by using the contrast mask is used to segment the pending image to produce the high contrast candidate region, so as to commonly determine the redeye region to be compensated with assistance of the color candidate region, such that the redeye region with lower red component can still be detected according to the invention. Therefore, accuracy and tolerance for determining the redeye region are increased. Moreover, a more accurate detection method for the candidate regions is further provided, so that even if a proportion of the region that generates the redeye phenomenon in the pupil is different, it can still be determined whether the region is the redeye region.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image processing method for redeye correction, comprising:
receiving a pending image, detecting a face region of the pending image, and setting at least one region of interest (ROI) in the face region;
segmenting the at least one ROI according to a color model to produce a plurality of candidate regions;
filtering each of the candidate regions separately according to a candidate region filtering method, and determining whether or not a color candidate region is produced after filtering;
if the color candidate is produced after filtering, calculating luminance values of a plurality of pixels in the at least one ROI by using a contrast mask, and segmenting the at least one ROI by using a calculated luminance distribution to produce a high contrast candidate region; and
taking an overlapped portion between the color candidate region and the high contrast candidate region as a redeye region, and correcting the redeye region to produce a corrected image.

2. The image processing method as claimed in claim 1, wherein the color candidate region is not produced after filtering, the image processing method further comprises:
filtering the high contrast candidate region according to the candidate region filtering method, and directly taking the filtered high contrast candidate region as the redeye region, so as to correct the redeye region.

3. The image processing method as claimed in claim 1, wherein the step of segmenting the at least one ROI by using the contrast mask to generate the high contrast candidate region comprises:
using the contrast mask to calculate the luminance values of a plurality of the pixels in the at least one ROI to generate a plurality of response values;
positioning a reference center point according to the response values;
calculating luminance values of a plurality of pixels in a neighboring region of the reference center point to generate a median luminance value and a standard deviation; and
segmenting the at least one ROI according to the luminance distribution formed by the median luminance value and the standard deviation, so as to generate the high contrast candidate region.

4. The image processing method as claimed in claim 3, wherein the step of positioning the reference center point according to the response values comprises:
selecting a position of the at least one ROI corresponding to a center point of the contrast mask to serve as the reference center point when a maximum response value in the response values is generated.

5. The image processing method as claimed in claim 1, wherein the step of filtering each of the candidate regions according to the candidate region filtering method comprises:
taking a center of the candidate region as a round center, taking a first predetermined distance as a radius to form a first round region, and calculating saturation values of a plurality of pixels inside and outside the first round region to generate a first characteristic value;
determining whether the first characteristic value is greater than a threshold value; and
determining the candidate region to be the color candidate region when the first characteristic value is greater than the threshold value.

6. The image processing method as claimed in claim 5, further comprising:
taking the center of the candidate region as a round center, taking a second predetermined distance as a radius to form a second round region, and calculating saturation values of a plurality of pixels inside and outside the second round region to generate a second characteristic value;
determining whether the first characteristic value or the second characteristic value is greater than the threshold value; and
determining the candidate region to be the color candidate region when at least one of the first characteristic value and the second characteristic value is greater than the threshold value.

7. The image processing method as claimed in claim 1, further comprising:
analysing a relative position relationship of the candidate regions in the face region to filter the color candidate region.

8. An image processing device for redeye correction, comprising:
a face detection module, receiving a pending image, detecting a face region of the pending image, and setting at least one region of interest (ROI) in the face region;
a color segment module, coupled to the face detection module, and segmenting the at least one ROI according to a color model to produce a plurality of candidate regions;
a filter module, coupled to the color segment module, and filtering each of the candidate regions to determine whether a color candidate region is produced after filtering;
a contrast mask module, coupled to the filter module, wherein if the filter module generates the color candidate region, the contrast mask module calculates luminance values of a plurality of pixels in the at least one ROI by using a contrast mask, and segments the at least one ROI by using a calculated luminance distribution to produce a high contrast candidate region; and
a redeye correction module, coupled to the filter module and the contrast mask module, taking an overlapped portion between the color candidate region and the high contrast candidate region as a redeye region, and correcting the redeye region to produce a corrected image.

9. The image processing device as claimed in claim 8, wherein when the filter module does not produce the color candidate region after filtering the candidate regions, the filter module further filters the high contrast candidate region to produce a filtered high contrast candidate region, and the redeye correction module directly takes the filtered high contrast candidate region as the redeye region, so as to correct the redeye region.

10. The image processing device as claimed in claim 8, wherein the contrast mask module comprises:
a positioning unit, using the contrast mask to calculate the luminance values of a plurality of the pixels in the at least one ROI to generate a plurality of response values, and positioning a reference center point according to the response values;
a calculation unit, coupled to the positioning unit, and calculating luminance values of a plurality of pixels in a neighboring region of the reference center point to generate a median luminance value and a standard deviation; and
a luminance segment unit, coupled to the calculation unit, and segmenting the at least one ROI according to the luminance distribution formed by the median luminance value and the standard deviation to generate the high contrast candidate region.

11. The image processing device as claimed in claim 10, wherein when the positioning unit generates a maximum response value in the response values, the positioning unit selects a position of the at least one ROI corresponding to a center point of the contrast mask to serve as the reference center point.

12. The image processing device as claimed in claim 8, wherein the filter module takes a center of each of the candidate region generated by the color segment module as a round center, and takes a first predetermined distance as a radius to form a first round region, the filter module calculates saturation values of a plurality of pixels inside and outside the first round region to generate a first characteristic value, and the filter module determines the candidate region with the first characteristic value being greater than a threshold value to be the color candidate region.

13. The image processing device as claimed in claim 12, wherein the filter module takes a second predetermined distance as a radius to form a second round region, and calculates saturation values of a plurality of pixels inside and outside the second round region to generate a second characteristic value, and the filter module determines the candidate region with at least one of the first characteristic value and the second characteristic value being greater than the threshold value as the color candidate region.

14. The image processing device as claimed in claim 8, wherein the filter module analyses a relative position relationship of the candidate regions generated by the color segment module, and filters the color candidate region according to an analysing result.
